(19) United States
(12) Patent Application Publication
(10) Pub. No.: US 2011/0254973 A1
(43) Pub. Date: Oct. 20, 2011

(54) IMAGE PROCESSING APPARATUS AND IMAGE PROCESSING METHOD

(75) Inventor: Tomohiro Nishiyama, Tokyo (JP)

(73) Assignee: CANON KABUSHIKI KAISHA, Tokyo (JP)

(21) Appl. No.: 13/082,812

(22) Filed: Apr. 8, 2011

(30) Foreign Application Priority Data
Apr. 16, 2010 (JP) 2010-095096

(51) Int. Cl. H04N 5/228

(52) U.S. Cl. 348/222.1; 348/E05.031

(57) ABSTRACT

An image processing apparatus includes an acquisition unit configured to acquire a captured image selected according to specified viewpoint information from a plurality of captured images captured by a plurality of imaging units at different viewpoint positions, a generation unit configured to generate an image according to the specified viewpoint information using the viewpoint information of the selected captured image and the specified viewpoint information from the selected captured image, and a blurring processing unit configured to execute blurring processing on the generated image, wherein, when an imaging unit corresponding to a captured image for a target frame is different from an imaging unit corresponding to a captured image for a frame adjacent to the target frame, the blurring processing unit executes blurring processing on the generated image corresponding to the target frame.

### BACKGROUND OF THE INVENTION

1. Field of the Invention

The present invention relates to an image processing apparatus and an image processing method for generating a virtual viewpoint video image using a plurality of camera images.

2. Description of the Related Art

A video image seen from moving virtual viewpoints, video images can be reproduced in various manners using a plurality of cameras that capture one scene. For example, a plurality of cameras are set at different viewpoints, so that video image data (multi-viewpoint video image data) captured by the cameras at different viewpoints may be switched and continuously reproduced.

For such image reproduction, Japanese Patent Application No. 2004-088247 discusses a method for reproducing smooth video images after adjustment of brightness and tint of the images obtained by a plurality of cameras. Japanese Patent Application No. 2008-217243 discusses improvement in image continuity, which uses video images actually captured by a plurality of cameras and additional video images at intermediate viewpoints, which are interpolated based on the actually captured video images.

Japanese Patent Application No. 2004-088247, however, has a disadvantage. In the method, switching between cameras causes a skip in the video image. In the method of Japanese Patent Application No. 2008-217243, insertion of intermediate viewpoint images can improve the skip in the video image. The method, however, has another disadvantage that, in case of failure of generation of video images at the intermediate viewpoints, the resulting image becomes discontinuous.

### SUMMARY OF THE INVENTION

The present invention is directed to an image processing apparatus and method for generating a smooth virtual viewpoint video image by using blurring processing to reduce skips in the video image.

According to an aspect of the present invention, an image processing apparatus includes a acquisition unit configured to acquire a captured image selected according to specified viewpoint information from a plurality of captured images captured by a plurality of imaging units at different viewpoint positions, a generation unit configured to generate an image according to the specified viewpoint information using the viewpoint information of the selected captured image and the specified viewpoint information from the selected captured image, and a blurring processing unit configured to execute blurring processing on the generated image, wherein, when an imaging unit corresponding to a captured image for a target frame is different from an imaging unit corresponding to a captured image for a frame adjacent to the target frame, the blurring processing unit executes blurring processing on the generated image corresponding to the target frame.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are schematic diagrams illustrating a system for generating a virtual viewpoint video image using a plurality of camera images according to a first exemplary embodiment.

FIG. 2 is a block diagram illustrating an image processing system of the first exemplary embodiment.

FIG. 3 is a block diagram illustrating a blurred image generation unit 208.

FIGS. 4A and 4B illustrate attribute information of a camera.

FIG. 5 is a flowchart illustrating operations of the first exemplary embodiment.

FIG. 6 illustrates correspondence between coordinates on a virtual screen and real physical coordinates.

FIG. 7 illustrates virtual viewpoint images obtained when cameras are switched.

FIGS. 8A and 8B illustrate a process for calculating a motion vector.

FIG. 9 illustrates effect of blurred images.

FIG. 10 is a block diagram illustrating an image processing method according to a second exemplary embodiment.

FIG. 11 is a schematic diagram illustrating area division of a virtual viewpoint image.

FIG. 12 is a block diagram illustrating an image processing system of a third exemplary embodiment.

### DESCRIPTION OF THE EMBODIMENTS

Various exemplary embodiments, features, and aspects of the invention will be described in detail below with reference to the drawings.

In the present exemplary embodiment, an image processing apparatus is described, which generates a smooth moving image seen from a virtual viewpoint using a plurality of fixed cameras (imaging units). In the present exemplary embodiment, for example, a scene with a plurality of people is captured from high vertical positions using a plurality of fixed cameras.

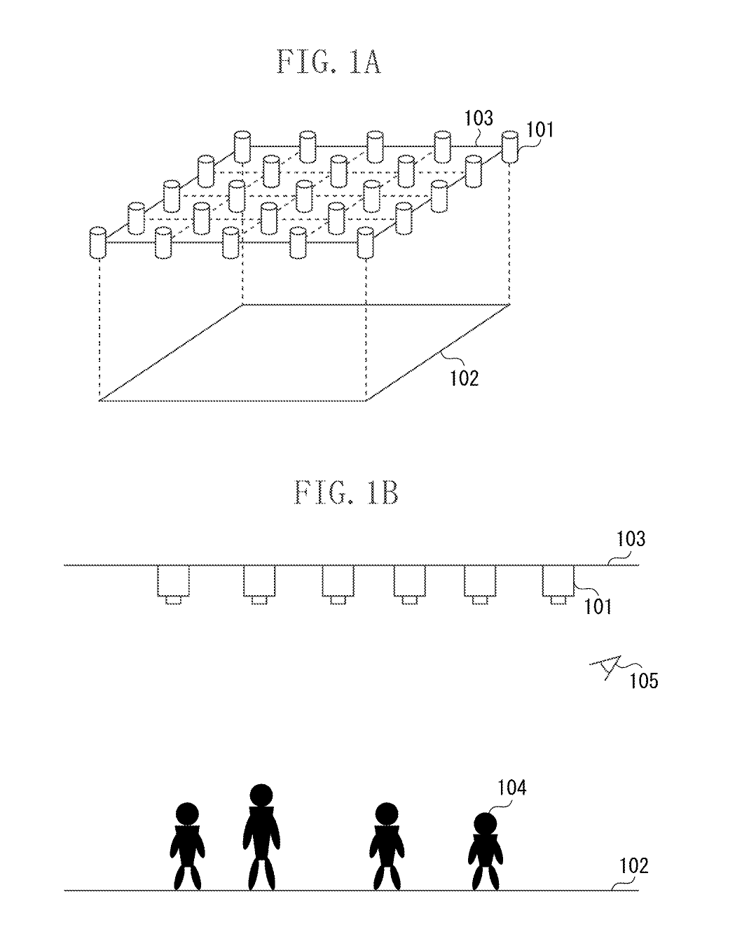

FIG. 1 is a schematic diagram illustrating a system for generating a virtual viewpoint video image using a plurality of camera images according to the present exemplary embodiment. FIG. 1A illustrates camera positions in three dimensions, which includes cameras 101, a floor face 102, and a ceiling 103. FIG. 1B is a projection of FIG. 1A in two dimensions illustrating the camera positions and objects (persons). In FIG. 1B, an object 104 is an object to be image captured.

In the present exemplary embodiment, a virtual viewpoint 105 is determined to have viewpoint information defined by a preset scenario. A plurality of fixed cameras captures video images in real time, which are used to generate a video image seen from the virtual viewpoint 105 according to the scenario.

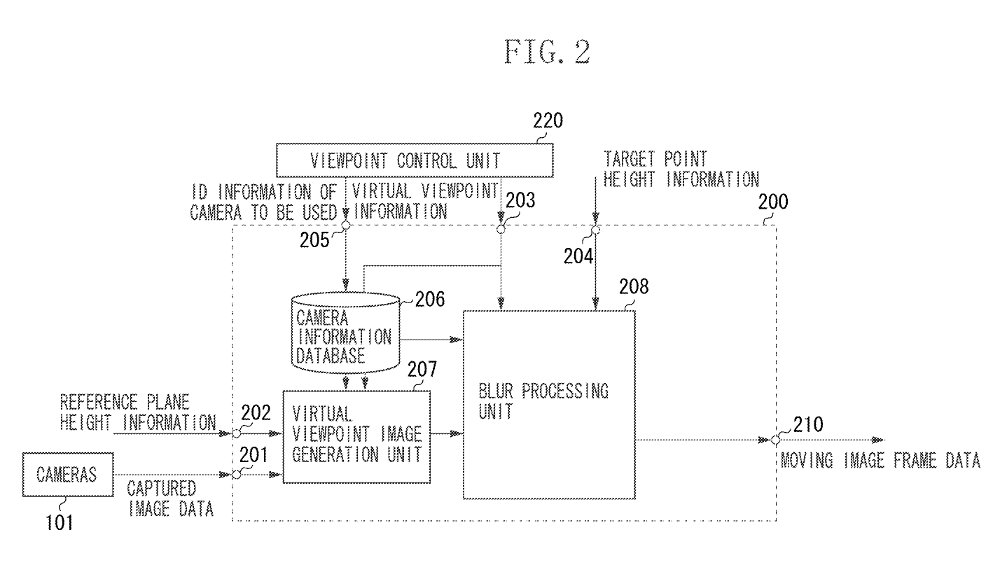

FIG. 2 is a block diagram illustrating an example image processing apparatus according to the present exemplary embodiment.

A viewpoint control unit 220 stores ID information of cameras to be used and attribute information of the virtual viewpoint for every “m” frame (m=1 to M) of a moving image according to the scenario. The viewpoint control unit 220 outputs the ID information of the camera to be used and the attribute information of the virtual viewpoint, in sequence based on the frame reference numbers.

Image data captured by the cameras 101 is input through a captured image data input terminal 201. Reference-plane height information is input through a reference-plane height information input terminal 202. In the present exemplary embodiment, the reference plane is the floor face 102 at the height (H_{floor}) Z=0. Attribute information of the virtual viewpoint is input from the viewpoint control unit 220 through a virtual-viewpoint information input terminal 203. The height information of a point-of-interest is input through a point-of-interest height information input terminal 204.

In the present exemplary embodiment, the point-of-interest is at a person's head, and the person's standard height is set as the height of the point-of-interest (H_{head}). The ID information (ID(m)) of a camera to be used at a frame (m) to be processed is input through a camera ID information input terminal 205. A camera information database 206 stores a camera ID of each of the cameras 101 in association with attribute information (position and orientation, and angle of view) of the camera 101.

The camera information database 206 outputs the ID information of a camera used for a target frame (m) to be processed and the attribute information corresponding to the ID information, which are input from the viewpoint control unit 220. A virtual viewpoint image generation unit 207 inputs image data captured by the camera corresponding to the ID information of the camera to be used that is input from the camera information database 206. The virtual viewpoint image generation unit 207 then generates image data for the virtual viewpoint using the captured image data, based on the reference-plane height information and the attribute information of the virtual viewpoint.

A blurring processing unit 208 performs blurring processing on the generated image data for the virtual viewpoint, based on the camera attribute information input from the camera information database 206, the point-of-interest height information, and the attribute information of the virtual viewpoint input from the viewpoint control unit 220.

The image processing unit 200 performs the above processing on each frame, and outputs video image data for the virtual viewpoint according to the scenario through a moving image frame data output unit 210.

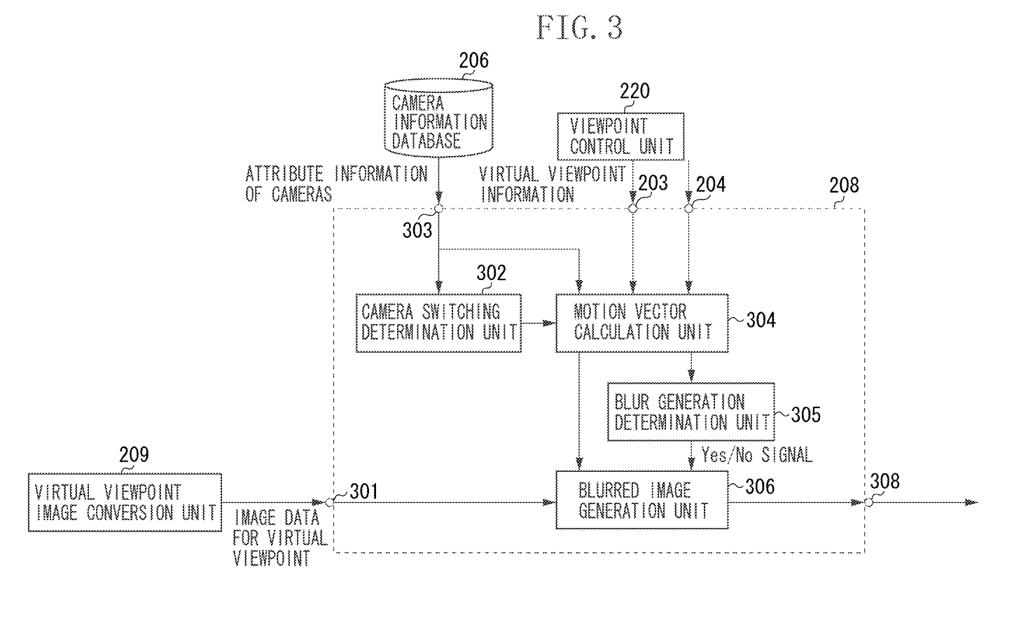

FIG. 3 is a block diagram illustrating the blurring processing unit 208. The image data for the virtual viewpoint generated by the virtual viewpoint image generation unit 207 is input through a virtual-viewpoint image data input terminal 301. A camera switching determination unit 302 determines whether the camera to be used for a target frame m is switched to another camera to be used for a next frame m+1, using the camera IDs serially input through the terminal 303 from the camera information database 206. The camera switching determination unit 302 then outputs the determination to a motion vector calculation unit 304. In the present exemplary embodiment, the camera switching determination unit 302 transmits a Yes signal when cameras are switched, and transmits a No signal when cameras are not switched.

The motion vector calculation unit 304 calculates a motion vector that represents a skip of the point-of-interest in a virtual viewpoint image, using the point-of-interest height information, the virtual viewpoint information, and the attribute information of the cameras 101. The motion vector calculation unit 304 calculates a motion vector upon a reception of a Yes signal from the camera switching determination unit 302.

A blur generation determination unit 305 transmits a Yes signal when the motion vector has a norm equal to or more than a threshold Th. The blur generation determination unit 305 transmits a No signal when the motion vector has a norm less than the threshold Th. A blurred image generation unit 306 performs blurring processing on the image data for the virtual viewpoint using a blur filter that corresponds to the motion vector calculated by the motion vector calculation unit 304, upon a reception of a Yes signal from the blur generation determination unit 305.

On the other hand, upon a reception of a No signal from the blur generation determination unit 305, the blurred image generation unit 306 outputs the image data for the virtual viewpoint as it is. The blurred image data generated by the blurred image generation unit 306 is output through a blurred image data output terminal 308.

The attribute information of cameras stored in the camera information database 206 is described below.

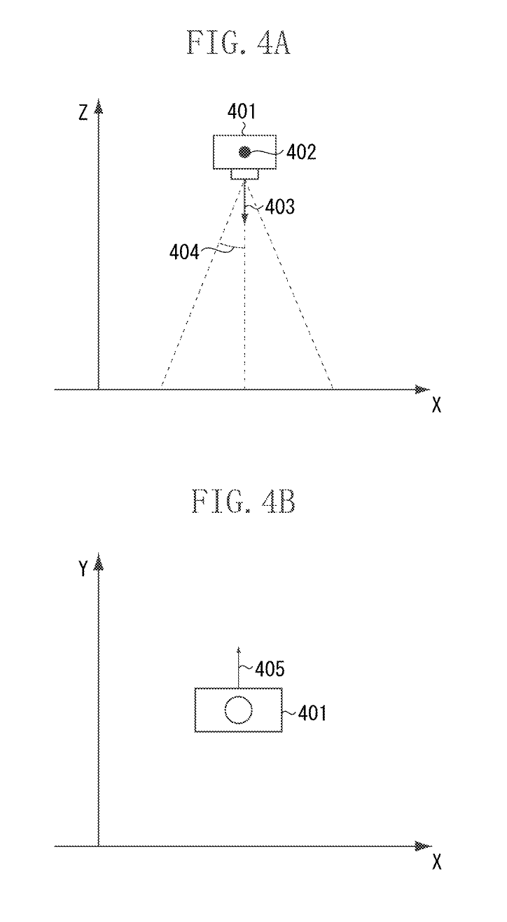

FIG. 4 illustrates the characteristics of a camera having an ID number (camera ID information). FIG. 4A is a projection diagram of a plane Y=const. FIG. 4B is a projection diagram of a plane Z=const.

FIG. 4A illustrates a camera 401 having an ID number. The camera 401 has the center of gravity at the point 402. The camera 401 is disposed in the orientation represented by a vector 403 that is a unit normal vector. The camera 401 provides an angle of view that is equal to an angle 404. In FIG. 4B, a unit vector 405 extends upward from the camera 401.

The camera information database 206 stores the camera ID numbers and the attribute information corresponding to each of the camera ID numbers. The camera attribute information includes the position vector of the center of gravity 402, the unit normal vector 403 representing the lens orientation, the value of tangent 8 of the angle 404 (θ) corresponding to the angle of view, and the unit vector 405 representing the upward direction of the camera 401.

Similar to the camera attribute information, the attribute information of the virtual viewpoint stored in the viewpoint control unit 220 includes the position vector of the center of gravity 402 of a virtual camera at a virtual viewpoint, the unit normal vector 403 representing the lens orientation, the value of tangent θ of the angle 404 (θ) corresponding to the angle of view, and the unit vector 405 representing the upward direction of the camera.

### <Generation of Image Data for Virtual Viewpoint>

A process to generate image data for a virtual viewpoint performed by the virtual viewpoint image generation unit 207 is described below.

First, image coordinates of a virtual viewpoint image of a target frame m is converted into physical coordinates. Next, the physical coordinates are converted into image coordinates of an image captured by a camera having an ID(m). Through this process, the image coordinates of an image at the virtual viewpoint are associated with image coordinates of an image captured by a camera having the ID(m). Based on the association, the pixel value of an image captured by the camera of the ID(m) at each of the image coordinates that are associated with each of the image coordinates of the image at the virtual viewpoint is obtained, so that image data for the virtual viewpoint is generated.

(Conversion of Image Coordinates into Physical Coordinates)

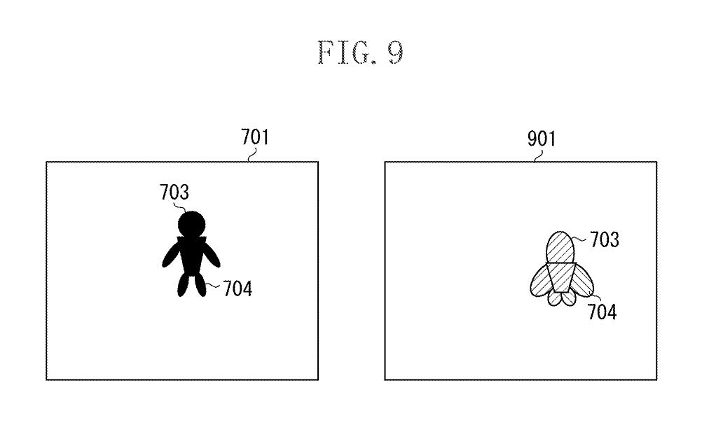

The formula for converting image coordinates of an image at a viewpoint into physical coordinates is described below. In the formula, C is position vector of the center of gravity 402 of the camera 401 in FIGS. 9A and 9B, n is unit normal vector 403, t is unit vector 405 in the upward direction of the camera, γ is tan θ of the angle of view 404.

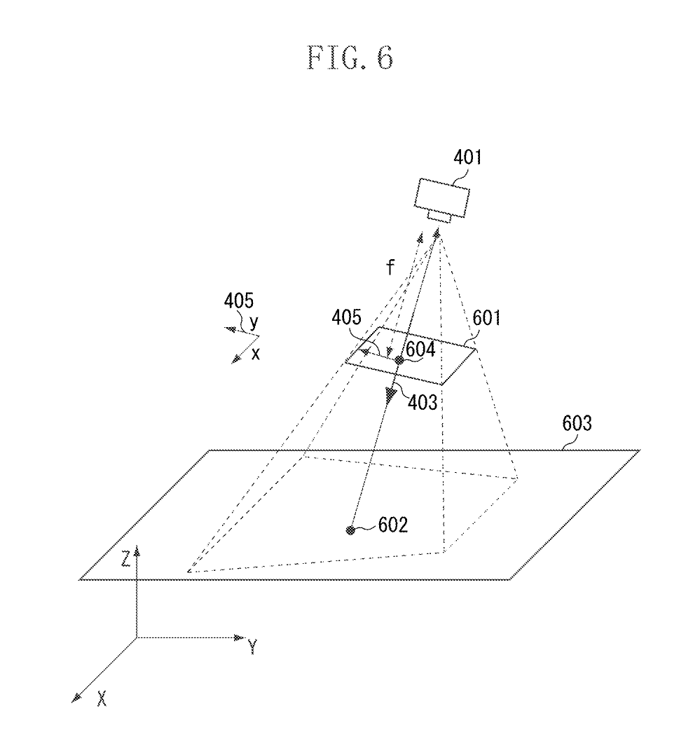

FIG. 6 illustrates a projection of an object onto an image corresponding to a viewpoint of the camera 401. In FIG. 6, a plane 601 is a virtual screen for the camera 401, a point 602 is an object to be imaged, and a plane 603 is a reference plane where the object is located. A point 604 is where the object 602 is projected onto the virtual screen 601. The center of gravity 402 is separated from the virtual screen 601 by a distance f. A point 604 has coordinates (x, y) on the virtual screen 601. The object has physical coordinates (X, Y, Z).

In the present exemplary embodiment, the X and Y axes are set so that the X-Y plane of the XYZ coordinate that defines the physical coordinates includes a flat floor face. The Z axis is set in the direction of the height of the camera position. In the present exemplary embodiment, the floor face is set as a reference plane, and thereby the floor face is placed at the height H_{floor} where a z value is 0.

The virtual screen is a plane defined by a unit vector t and a unit vector u≡t×n. The virtual screen is also represented by the following formula:

$$f = \frac{w}{2 γ} \qquad ( 1 )$$

where γ is tan θ of angle of view, and w is vertical width (pixels) of image.

A physical vector x (i.e., a vector extended from the center of gravity of the camera 401 to the point 604) of the point 604 can be represented by the following formula:

x=xu+yt+fn+C (2)

The object 602 lies on the extension of the physical vector x. Accordingly, the physical vector X of the object 602 (i.e., the vector extended from the center of gravity 401 of the camera to the object 602) can be represented by the following formula with a constant a:

X=a(xu+yt+fn)+C (3)

The height Z of the object is, known, and can be represented by the following formula based on Formula (3):

Z=a(xu_{z}+yt_{z}+fn_{z})+C (4)

When Formula (4) is solved for the constant a, the following formula is obtained:

$$a = \frac{Z - {C}_{z}}{{xu}_{z} + {yt}_{z} + {fn}_{z}} \qquad ( 5 )$$

Substitution of Formula (5) into Formula (3) results in the following formula, which is the conversion formula to obtain a physical coordinate of an object from a point (x, y) on an image:

$$X = ( Z - {C}_{z} ) \frac{xu + yt + fn}{{xu}_{z} + {yt}_{z} + {fn}_{z}} + C$$

$$f = \frac{w}{2 γ}$$

For simplicity, the conversion formula is hereafter expressed as:

X=f(t,n,C,Z,γ,w;x,y) (6)

(Conversion of Physical Coordinate into Image Coordinate)

The conversion formula for converting a physical coordinate of an object into a coordinate on an image captured by a camera at a viewpoint is described. As described above, the physical vector X of the object 602 can be represented by Formula (3):

X=a(xu+yt+fn)+C

The inner product of both sides of Formula (3) with u, and the orthonormality of u, t, and n lead to Formula (7):

$$x = \frac{u \cdot ( X - C )}{a} \qquad ( 7 )$$

Similarly, Formula (7) with application of t^{t} and n^{t} lead to Formula (8):

$$( \begin{matrix}x \\ y \\ f\end{matrix} ) = \frac{1}{a} ( \begin{matrix}{u}^{t} \\ {t}^{t} \\ {n}^{t}\end{matrix} ) ( X - C ) \qquad ( 8 )$$

When Formula (8) is solved for the third line, the following formula is obtained:

$$a = \frac{1}{f} n \cdot ( X - C ) \qquad ( 9 )$$

which results in the following formula to calculate coordinates (x, y) on an image using the physical vector X:

$$( \begin{matrix}x \\ y\end{matrix} ) = \frac{f}{n \cdot ( X - C )} ( \begin{matrix}{u}^{t} \\ {t}^{t}\end{matrix} ) ( X - C ) \\ f = \frac{w}{2 γ} \qquad ( 10 )$$

For simplicity, the above formula is hereafter expressed as:

$$( \begin{matrix}x \\ y\end{matrix} ) = g ( t , n , C , γ , w ; X ) \qquad ( 11 )$$

### (Processing in Virtual Viewpoint Image Generation Unit 207)

The case where a virtual viewpoint image of an m^{th} frame is generated is described. A reference height is at a floor face having a height H_{floor} where Z=0 in the present exemplary embodiment. A method is described, for converting an image captured by a camera having an ID(m) into an image seen from an m^{th} virtual viewpoint.

The virtual viewpoint image generation unit 207 converts the coordinates on an image into physical coordinates, on the assumption that every object has a height H_{floor}. In other words, the present exemplary embodiment is based on the assumption that every object is positioned on the floor face.

The attribute information of the virtual viewpoint is input through the virtual-viewpoint information input terminal 203. Hereinafter, information of a virtual viewpoint is represented with a subscript f. Information about an m^{th} frame is represented with an argument m.

The conversion formula to convert coordinates (x_{f}, y_{f}) of a virtual viewpoint image of the m^{th} frame into physical coordinates is represented as follows based on Formula (6):

X(m)=f(t_{f}(m),n_{f}(m),C_{f}(m),H_{floor},γ_{f}w;x_{f},y_{f}) (12)

For simple description, the angle of view is set to be constant regardless of virtual viewpoint and frame.

The obtained physical coordinates are converted into coordinates of an image captured by a camera of an ID(m) by a formula based on Formula (11):

$$( \begin{matrix}x ( m ) \\ y ( m )\end{matrix} ) = g ( t ( m ) , n ( m ) , C ( m ) , γ , w ; X ( m ) ) \qquad ( 13 )$$

Using Formulae (12) and (13), the coordinates (x_{f}, Y_{f}) of the virtual viewpoint image can be associated with coordinates (x(m), y(m)) of an image captured by the camera of the ID(m). Accordingly, for each pixel of the virtual viewpoint image, a corresponding pixel value can be obtained using the image data captured by the camera of the ID(m). In this way, a virtual viewpoint image can be generated based on an image data captured by the camera of the ID(m).

### <Motion Vector Calculation Unit 304>

The virtual viewpoint image conversion unit 207 converts coordinates on the assumption that every object has a height H_{floor} (Z=0). In other words, the above conversion is performed on the assumption that every object is positioned on a floor face. Actual objects may, however, have heights different from the height H_{floor}.

If an image of an m^{th} frame and an image of the (m+1)^{th} frame are captured by a single camera (i.e., ID(m)=ID(m+1)), even when an object has a height different from the height H_{floor}, there is no skip between the virtual viewpoint image of the m^{th} frame and the virtual viewpoint image of the m+1^{th} frame. This is because the same conversion formula (Formula (11)) is used for the m^{th} frame and the m+1^{th} frame for conversion from physical coordinate to image coordinate.

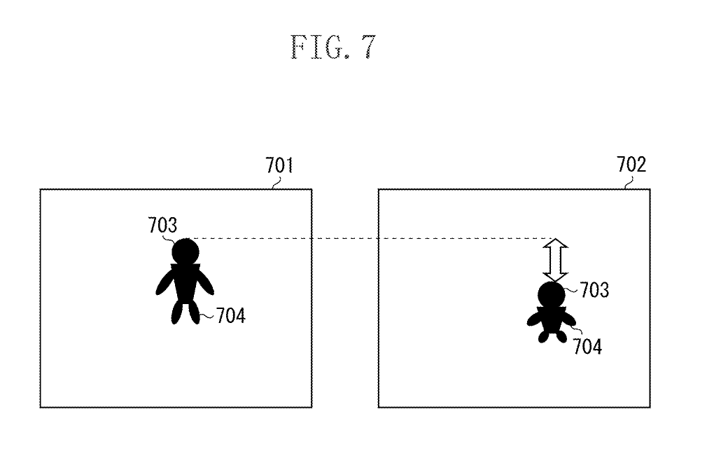

In contrast, when an image of an m^{th} frame and an image of the (m+1)^{th} frame are captured by different cameras (i.e., ID(m)≠ID(m+1)), a smooth moving image can be obtained with respect to an object (e.g., shoe) having a height H_{floor}, but there is a skip between the images of an object (e.g., person's head) having a height different from the height H_{floor}, as illustrated in FIG. 7. As described above for acquisition of Formula (4) from Formula (3), the height Z of the object is known.

In the present exemplary embodiment, a reference plane height is at a floor face having a height H_{floor} for every object. Consequently, if an object has a height different from a reference plane height, the conversion formula to convert image coordinate into physical coordinate causes error. This does not generate inappropriate images in a frame, but causes a skip between frames that are captured by different cameras.

In FIG. 7, an image 701 is obtained by converting an image captured by a camera of ID(m) into a virtual viewpoint image of an m^{th} frame. An image 702 is obtained by converting an image captured by a camera of ID (m+1) into a virtual viewpoint image of the (m+1)^{th} frame. An object person has a head 703 and a shoe 704. In the present exemplary embodiment, a scene with a plurality of people is captured from upper virtual viewpoints.

Thus, a head height which is considered to be the longest measurement from the floor face (H_{floor}) used to obtain an amount of movement of the object's head in an image at switching of cameras. In other words, a motion vector of a head on a virtual viewpoint image is obtained on the assumption that the head is located at coordinates (x₀, y₀) of the virtual viewpoint image, and the head is at a height H_{head} which is a person's standard height.

In the present exemplary embodiment, the coordinates (x₀, y₀) of the virtual viewpoint image are the center coordinates of the image. According to an amount of movement of the head at the center position, an amount of blurring with respect to the (m+1)^{th} frame is controlled.

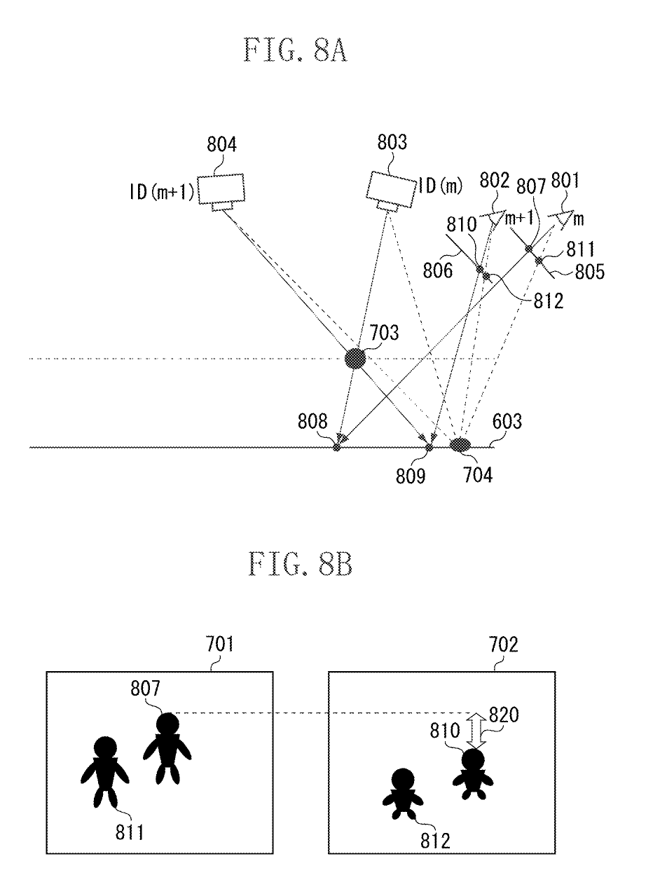

FIGS. 8A, 8B is a schematic diagram illustrating calculation of a motion vector of a head. FIG. 8A illustrates a virtual viewpoint 801 of the m^{th} frame, a virtual viewpoint 802 of the (m+1)^{th} frame, a camera of ID(m) 803, a camera of ID (m+1) 804, a virtual screen 805 for the virtual viewpoint 801, and a virtual screen 806 for the virtual viewpoint 802. In FIG. 8A, the point 807 is positioned on coordinates (x₀, y₀) on the virtual screen 805 for the m^{th} target frame. The point 808 is the projection of the point 807 on the floor face 603.

The point 809 is the projection of the head 703 from the camera 804 to the floor face 603. The point 810 is the projection of the point 809 on virtual screen 806. The point 811 is the projection of the shoe 704 on the virtual screen 805. The point 812 is the projection of the shoe 704 on the virtual screen 806.

FIG. 8B illustrates the head 703 and the shoe 704 on the image seen from an m^{th} virtual viewpoint and the image seen from the (m+1)^{th} virtual viewpoint. The vector 820 is a motion vector representing the skip of the head 703 between the image 701 and the image 702. The motion vector calculation unit 304 calculates a difference vector 820 between the image coordinate of the point 810 and the image coordinates (x₀, y₀) of the point 807.

The coordinate of the point 810 is calculated as follows. The physical coordinate X_{head} of the head 703 having a height H_{head} at a point-of-interest is calculated based on the image coordinates (x₀, y₀) at the m^{th} virtual viewpoint. The physical coordinate X_{floor} of the point 809, which is the projection of the calculated physical coordinate of the head 703 on the floor face 603 from the camera 804 having ID (m+1), is calculated. The physical coordinate X_{floor} of the point 809 is converted into an image coordinate on the (m+1)^{th} virtual screen 806 to obtain the coordinate of the point 810.

The calculation of the coordinate of the point 810 is described in more detail below.

The motion vector calculation unit 304 calculates the physical coordinates of the point 808 using Formula (14) according to Formula (6), based on the representative coordinates (x₀, y₀) (i.e., a coordinate of an image seen from a virtual viewpoint of the m^{th} frame) on the virtual screen 805 of the m^{th} frame:

X(m)=f(t_{f}(m),n_{f}(m),C_{f}(m),H_{floor},γ_{f},w;x₀,y₀) (14)

The physical coordinates X_{head} of the head 703 are located on a vector from the viewpoint position of the camera having ID(m) and the point 808. Accordingly, the physical coordinates X_{head} can be expressed as follows like Formula (13) using a constant b:

X_{head}=b(X(m)−C(m))+C(m) (15)

The physical coordinates X_{head} have a z component of a height H_{head}, which leads to Formula (16):

H_{head}=b(H_{floor}−C_{z}(m))+C_{z}(m) (16)

When Formula (16) is solved for the constant b, the following formula is obtained:

$${X}_{head} = \frac{{H}_{head} - {C}_{z} ( m )}{{H}_{floor} - {C}_{z} ( m )} ( X ( m ) - C ( m ) ) + C ( m ) \qquad ( 17 )$$

The motion vector calculation unit 304 calculates the physical coordinates X_{head} of the head 703 using Formula (17).

The motion vector calculation unit 304, then, calculates the physical coordinates X_{floor} of the point 809. The point 809 is located on the extension of a vector from the viewpoint position of the camera 804 having ID(m+1) and the physical coordinate X_{head} of the head 703. Accordingly, the motion vector calculation unit 309 calculates the physical coordinates X_{floor} of the point 809 using Formula (18) that is obtained based on the same consideration as in the calculation of the physical coordinate of the head 703:

$${X}_{floor} = \frac{{H}_{floor} - {C}_{z} ( m + 1 )}{{H}_{head} - {C}_{z} ( m + 1 )} ( {X}_{head} - C ( m + 1 ) ) + C ( m + 1 ) \qquad ( 18 )$$

The motion vector calculation unit 304, then, converts the physical coordinates X_{floor} of the point 809 into image coordinates (x, y) on the (m+1)^{th} virtual screen 806, using Formula (19) according to Formula (11):

$$( \begin{matrix}x \\ y\end{matrix} ) = g ( {t}_{f} ( m + 1 ) , {n}_{f} ( m + 1 ) , {C}_{f} ( m + 1 ) , {γ}_{f} , w ; {X}_{floor} ) \qquad ( 19 )$$

The motion vector 820 indicates a displacement of the object' head, which is set as a representative point, in an image. Accordingly, the motion vector calculation unit 304 calculates a motion vector v (x−x₀, y−y₀) based on the calculated image coordinates (x, y) and the image coordinates (x₀, y₀) of the representative point.

### <Blurred Image Generation Unit>

Based on the motion vector v calculated by the motion vector calculation unit 304, the blurred image generation unit 306 performs blurring processing on the image of the (m+1)^{th} frame in the direction opposite to the motion vector v, according to Formula (20):

$${I}_{blur} ( x , y ) = \frac{1}{{\int }_{0}^{1} d t α ( {v}_{x} t , {v}_{y} t )} {\int }_{0}^{1} d {tI}_{m + 1} ( x - β {v}_{x} t , y - β {v}_{y} t ) α ( {v}_{x} t , {v}_{y} t ) \qquad ( 20 )$$

In Formula (20), Iₘ₊₁(x, y) is virtual viewpoint image data of the (m+1)^{th} frame, α is weighting factor, and β is an appropriate factor. For example, β=1 and α=exp(−t²/2) which is a Gaussian weight. As described above, the blurred image generation unit 306 executes blurring processing in the direction according to a motion vector to the degree according to the vector.

FIG. 9 is a schematic diagram. In FIG. 9, the image 901 is obtained by blurring the image 702 according to Formula (20). Because the image 901 is blurred according to a video image skip, continuous reproduction of the images 701 and 901 results in a smooth moving image.

In the present exemplary embodiment, the image data of the (m+1)^{th} frame is blurred in the direction opposite to the motion vector v, but the image data of the m^{th} frame may be blurred in the direction of the motion vector v. Alternatively, the motion vector v may be divided into a plurality of vectors vᵢ, so that a plurality of frames are blurred according to the vectors vᵢ. As a result of the visual experiments, blurring of the (m+1)^{th} frame in the direction opposite to the motion vector v provides satisfactory image quality.

In the present exemplary embodiment, a motion vector is calculated using two adjacent frames. A motion vector may be, however, calculated using a target frame and its successive frames, such as a target frame and its previous and next frames, or a target frame and a plurality of neighboring frames.

### <Operations of Image Processing Apparatus>

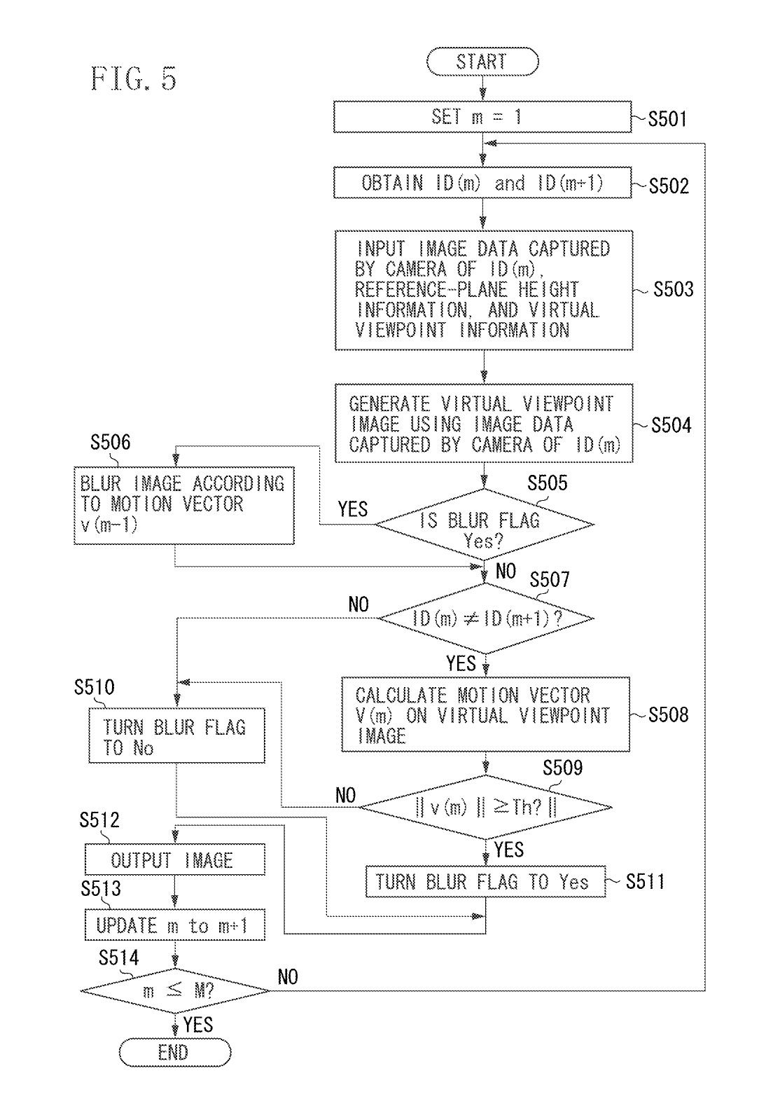

Operations of the image processing apparatus in FIG. 2 are described with reference to the flowchart in FIG. 5.

In step S501, the number of a frame of a virtual viewpoint moving image is set to be m=1. In step S502, a camera ID (ID(m)) to be used to capture image of an m^{th} frame and a camera ID (ID(m+1)) to be used for a next frame are obtained. In step S503, image data captured by the camera of the ID(m), reference-plane height information, and virtual viewpoint information, are respectively input through the input terminals 201, 202, and 203. The viewpoint image conversion unit 207 receives attribute information of the camera of the ID(m) from the camera information database 206. In step S504, a virtual viewpoint image seen from a virtual viewpoint is generated using the image data captured by the camera of the ID(m) based on the camera attribute information, the virtual viewpoint information, and the reference-plane height information.

In step S505, it is determined whether the blur generation determination unit 305 outputs a Yes signal (hereinafter, referred to as blur flag). The blur flag is set to No at the initial state (m=1). In step S506, if the blur flag is Yes (YES in step S505), the image is blurred according to a motion vector v(m−1) between the (m−1)^{th} frame and the m^{th} frame.

In step S507, the camera switching determination unit 302 determines whether the ID(m) is different from the ID(m+1). If they are different (YES in step S507), the camera switching determination unit 302 outputs a Yes signal. If they are the same (NO in step S507), the camera switching determination unit 302 outputs a No signal. In step S508, when the Yes signal is output, the motion vector calculation unit 304 receives information of the cameras ID(m) and ID(m+1) from the camera information database 206, and calculates a motion vector v(m) on the virtual viewpoint image based on the point-of-interest height information and the virtual viewpoint information.

In step S509, the blur generation determination unit 305 determines whether the motion vector has a norm greater than a threshold. In step S511, if the norm is greater than the threshold (YES in step S509), the blur generation determination unit 305 turns the blur flag to Yes. In the case of Yes in step S509, the process proceeds as follows. In step S512, a virtual viewpoint image or blurred image is output through the moving image frame data output terminal 210. In step S513, the target m^{th} frame is updated to an (m+1)^{th} frame.

In the case of No in step S507 or S509 (NO in step S507 or S509), in step S510, the blur flag is turned to No.

In step S514, when the number m is equal to or less than the total frame number M (NO in step S514), the processing returns to step S502. When the number m is greater than the total frame number M (YES in step S514), the processing ends.

As described above, according to the first exemplary embodiment, a motion vector of a point-of-interest between frames where cameras used are switched is calculated, so that blurring is performed according to the motion vector. This enables generation of smooth virtual viewpoint images.

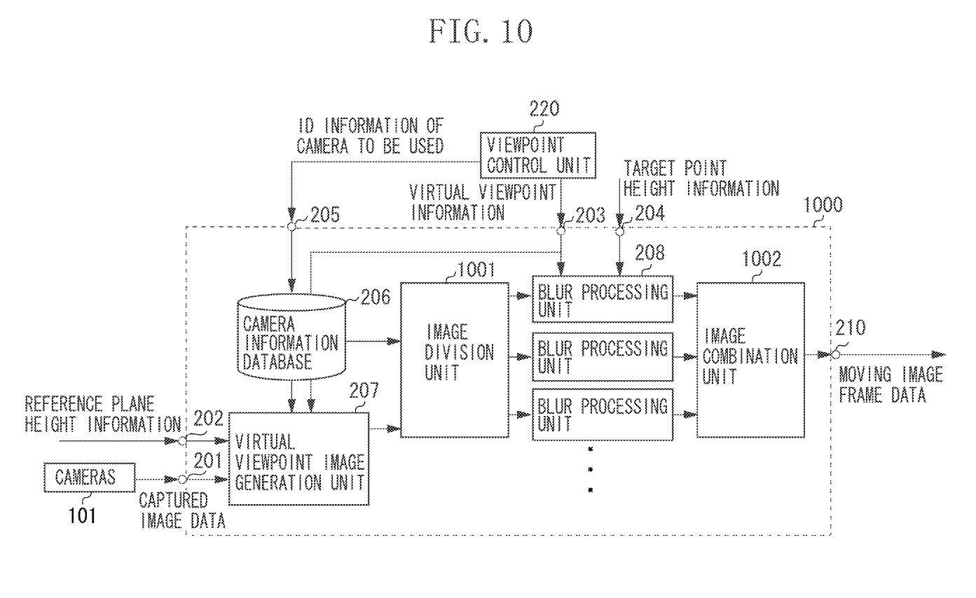

In the first exemplary embodiment, the blurred image generation unit 306 performs uniform blurring processing across an entire image. In a second exemplary embodiment, a virtual viewpoint image is divided into areas, so that a motion vector of each area is calculated. For each area, then, blur is performed according to a motion vector corresponding to each area. FIG. 10 is a block diagram illustrating an image processing apparatus according to a second exemplary embodiment. In FIG. 10, the elements similar to those of the image processing apparatus in FIG. 2 are designated with the same reference numerals, and the descriptions thereof are omitted.

An image division unit 1001 divides a virtual viewpoint image into a plurality of areas. An image combination unit 1002 combines blurred images generated by blur generation units 208. Basically, every blurred image generation unit 208 receives virtual viewpoint information and point-of-interest height information, which is not illustrated in FIG. 10 for simplicity of the figure.

Operations of the image processing apparatus in FIG. 10 are described. The image division unit 1001 receives data from the virtual viewpoint image conversion unit 207, and divides an image into a plurality of areas as specified.

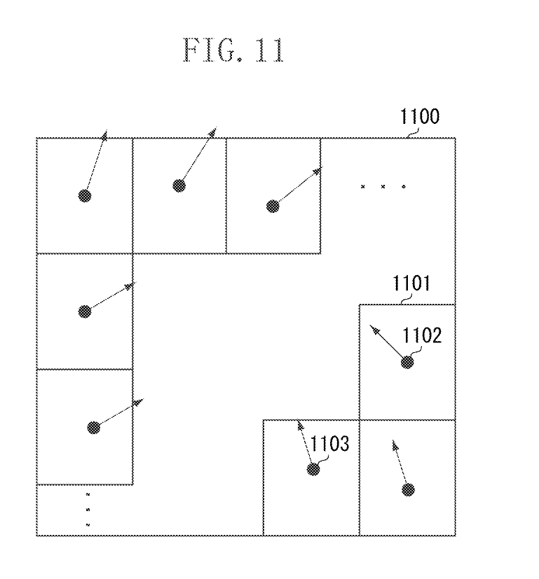

The blurred image generation unit 208 receives a representative point of each area, divided image data, and camera information. The blurred image generation unit 208, then, calculates a motion vector of each area, and performs blurring processing on each area. FIG. 11 is a schematic diagram illustrating such motion vectors.

In FIG. 11, a virtual viewpoint image 1100 includes a plurality of divided areas 1101. In FIG. 11, the areas are rectangles, but they may be other shapes. The point 1102 is a representative point of each area, from which a motion vector v 1103 of each area extends. Each of the blurred image generation units 208 performs blurring processing on each area using a corresponding motion vector v of the area. The image combination unit 1002, then, combines image data output from the plurality of blurred image generation unit 208.

As described above, according to the second exemplary embodiment, appropriate blurring processing is achieved for each area of an image, resulting in smooth virtual viewpoint video images.

In a third exemplary embodiment, a case where sharpness processing is performed on a virtual viewpoint image is described. Image data is sometimes enlarged when a virtual viewpoint image is generated using an image captured by a camera. In this case, interpolation processing in the enlargement makes the image blurred. In the present exemplary embodiment, to reduce such image blur, sharpness processing is performed on a virtual viewpoint image according to a scale factor.

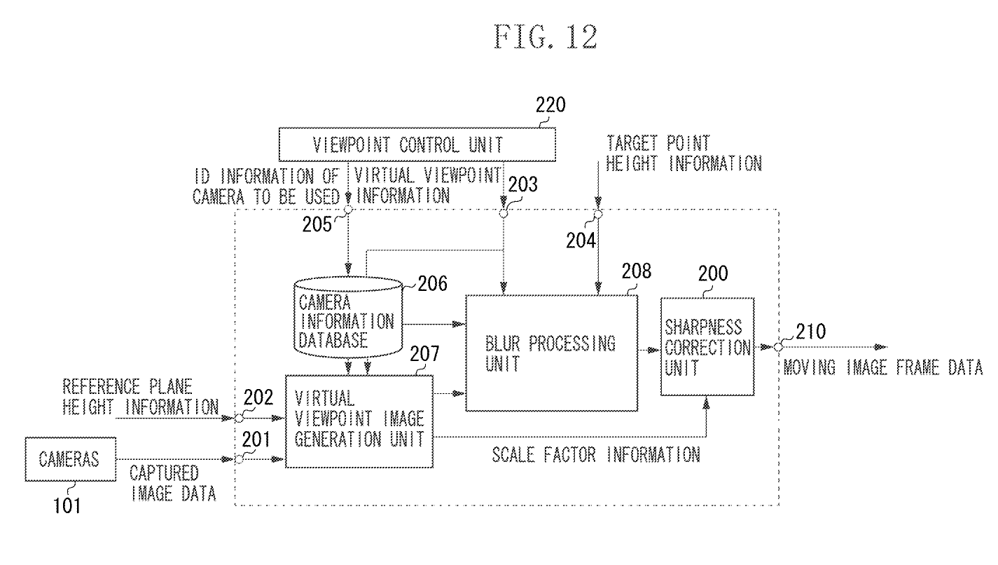

FIG. 12 is a block diagram of the present exemplary embodiment. In FIG. 12, the elements similar to those of the image processing apparatus in FIG. 2 are designated with the same reference numerals, and descriptions thereof are omitted. A sharpness correction unit 1201 executes sharpness processing according to scale factor information in a virtual viewpoint image conversion unit.

Operations of the image processing apparatus illustrated in FIG. 12 are described below. The sharpness correction unit 1201 receives scale factor information that is used in generation of a virtual viewpoint image from the virtual viewpoint image generation unit 207. The sharpness correction unit 1201, then, executes sharpness correction according to the scale factor information on the generated virtual viewpoint image data.

At this point, if the blurred image generation unit 208 performs blurring processing, no sharpness correction is executed. This is because blurring processing eliminates effects of sharpness correction. In this way, blurring processing and sharpness processing are set to be exclusive of each other, reducing load of the system.

The scale factor is obtained as follows. Two representative points on a virtual viewpoint image are selected: for example, points (x₀, y₀) and (x₁, y₀). The coordinates thereof are converted into the points (x₀(m), y₀(m)) and (x₁(m), y₀(m)) on an image captured by a camera ID(m) using Formulae (12) and (13). The conversion scale factor in the conversion is calculated as follows:

$$α ≡ \frac{\vert {x}_{1} - {x}_{0} \vert}{\vert {x}_{1} ( m ) - {x}_{0} ( m ) \vert} \qquad ( 21 )$$

According to the present exemplary embodiment, sharpness processing is adaptively executed, which enables effective generation of high quality virtual viewpoint images.

In the first to third exemplary embodiments, a virtual viewpoint is preset based on a scenario, but may be controlled in real time according to an instruction from a user. In addition, a motion vector at the center of an image is calculated in the above exemplary embodiments, but a motion vector at a different position may be used. Alternatively, a plurality of motion vector at a plurality of positions may be used to calculate statistical values such as average. In the first to third exemplary embodiments, the position of a main object may be detected based on an image, so that a motion vector is obtained based on the detected position.

In the first to third exemplary embodiments, blurring processing is executed to obscure a skip between frames, but blurring processing may be executed for other purposes such as noise removal. In the latter case, blurring processing is executed using a combination of a filter to obscure skip and another filter for another purpose.

The present invention also can be achieved by providing a recording medium storing computer-readable program code of software to execute the functions of the above exemplary embodiments, to a system or apparatus. In this case, a computer (or central processing unit or micro-processing unit) included in the system or apparatus reads and executes the program code stored in the recording medium to achieve the functions of the above exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-095096 filed Apr. 16, 2010, which is hereby incorporated by reference herein in its entirety.

What is claimed is:

1. An image processing apparatus, comprising:
an acquisition unit configured to acquire a captured image selected according to specified viewpoint information from a plurality of captured images captured by a plurality of imaging units at different viewpoint positions;
a generation unit configured to generate an image according to the specified viewpoint information using the viewpoint information of the selected captured image and the specified viewpoint information from the selected captured image; and
a blurring processing unit configured to execute blurring processing on the generated image,
wherein, when an imaging unit corresponding to a captured image for a target frame is different from an imaging unit corresponding to a captured image for a frame adjacent to the target frame, the blurring processing unit executes blurring processing on the generated image corresponding to the target frame.

2. The image processing apparatus according to claim 1, wherein the generation unit generates an image corresponding to the specified viewpoint information from the selected captured image by associating pixels of the selected captured image with pixels of the captured image corresponding to the specified viewpoint information through a reference plane defined by reference plane information based on the viewpoint information of the selected captured image, the specified viewpoint information, and the reference plane information.

3. The image processing apparatus according to claim 1, wherein the blurring processing unit calculates a motion vector of a point-of-interest between the target frame and the adjacent frame of the target frame, and controls a direction and degree of blurring processing to be executed according to the motion vector.

4. The image processing apparatus according to claim 1, wherein the blurring processing unit does not execute blurring processing on the generated image corresponding to the target frame when the imaging unit corresponding to the image for the target frame is identical to the imaging unit corresponding to the captured image for the frame adjacent to the target frame.

5. The image processing apparatus according to claim 1, further comprising a sharpness processing unit configured to execute sharpness processing on the generated image,
wherein the sharpness processing unit does not execute sharpness processing on the generated image on which the blurring processing unit executed the blurring processing.

6. An image processing method, comprising:
acquiring a captured image selected according to specified viewpoint information from a plurality of captured images captured by a plurality of imaging units at different viewpoint positions;
generating an image according to the specified viewpoint information using the viewpoint information of the selected captured image and the specified viewpoint information from the selected captured image; and
executing blurring processing on the generated image,
wherein the blurring processing is executed on the generated image corresponding to the target frame when an imaging unit corresponding to a captured image for a target frame is different from an imaging unit corresponding to a captured image for a frame adjacent to the target frame.

7. A non-transitory computer-readable storage medium storing a computer program which is read and executed by a computer to cause the computer to execute the processing defined in claim 6.
